(19) United States
(12) Patent Application Publication
(10) Pub. No.: US 2016/0219855 A1
(43) Pub. Date: Aug. 4, 2016

(54) Fishing Rod Strike Detector

(71) Applicants: Steven Turner, Arvada, CO (US); John Ismert, Lenexa, KS (US)

(72) Inventors: Steven Turner, Arvada, CO (US); John Ismert, Lenexa, KS (US)

(21) Appl. No.: 15/010,015

(22) Filed: Jan. 29, 2016

Related U.S. Application Data
(60) Provisional application No. 62/109,094, filed on Jan. 29, 2015.

(51) Int. Cl. A01K 97/12; H04W 4/00

(52) U.S. Cl. CPC A01K 97/125; H04W 4/008

(57) ABSTRACT

A fishing rod alert device is provided that monitors the motion of a fishing rod and sends a wireless alert to a user's handheld device when the lure of the fishing rod is struck by a fish. The device comprises an elongated member with a series of attachments that secure the device along the length of a fishing rod. The device includes a processor, a motion sensor, and a radio frequency transmitter. Motion of the fishing rod is detected by the motion detector, which sends signals to the processor. Upon determining that a fish has struck the line based on the motion signals, the processor directs the transmitter to send radio frequency signals over a network or directly to a user's handheld electronic device. The handheld electronic device receives the signals and alerts the user though one or more means.

### CROSS REFERENCE TO RELATED APPLICATION

This application claims the benefit of U.S. Provisional Application No. 62/109,094 filed on Jan. 29, 2015. The above identified patent application is herein incorporated by reference in its entirety to provide continuity of disclosure.

### BACKGROUND OF THE INVENTION

### Field of the Invention

The present invention relates to fishing rods and devices that detect when a fish has struck the line. More specifically, the present invention relates to a fishing rod device that affixes to a fishing rod and uses a sensor to measure movement of the rod. Movement of the rod is analyzed, and an alert is sent to the fisherman via visual, audible, and radio frequency means when the device determines a fish has struck the line.

It is common while fishing to support a fishing rod from a holder or similar support while allowing the lure to float freely. The user does not have to manually handle the rod and when a fish strikes the lure, the user can actively handle the rod to reel in the fish. However, there are instances when the user is not immediately present to grasp the rod when a fish strikes. If the user is not nearby, a fish may strike the line and free itself before the user is able to interact with the rod. If the user is in a position where he cannot see or hear the rod, the user may miss the strike altogether. The present invention provides a tool that affixes to a fishing rod to alert a user via wireless communication and other means when a fish has struck the line.

In particular, a fishing rod alert device is provided for notifying a fisherman user of a potentially struck line and a hooked fish. The device includes a combination motion sensor and transmitter with rod attachments thereon for attachment of the device to a fishing rod. The device can identify the movement of the fishing rod, which often happens when a fish bite the lure or a fish has been hooked (i.e. a fish has struck the line). Thereafter, the transmitter of the device sends a wireless signal either over a network or directly to a remote receiver, whereby the receiver can be a handheld electronic device (i.e. a smartphone or similar personal device) that is capable of receiving radio frequency signals directly from the transmitter or over a network. The handheld electronic device produces an alert based on the received signal, which may include an audio recording, vibration, or visual aid for indicating movement of the of the fishing rod.

The present invention transmits an alert signal to a fisherman's handheld device or equivalent when motion on their fishing rod is detected. The device affixes via rod attachments to the fishing rod and uses wireless signals rather than purely audio or visual alert notifications. Therefore, the fishermen user can be alerted when away from the rod and outside of visual or audible range thereof. The device therefore increases the potential for a user to recognize a struck line and handle the rod to reel in a fish before the fish releases from the line and escapes.

### SUMMARY OF THE INVENTION

The following summary is intended solely for the benefit of the reader and is not intended to be limiting in any way. The present invention provides a new fishing rod alert device that can be utilized for providing convenience for the user when monitoring a fishing rod with a lure extended without being present to feel, visualize, or hear the rod move after being struck.

It is therefore an object of the present invention to provide a new and improved fishing rod alert device that has all of the advantages of the prior art and none of the disadvantages.

It is another object of the present invention to provide a fishing rod alert device that comprises an elongated member adapted to be placed along a rod of a fishing rod. The elongated member has a length and an arcuate cross section with a curved interior that is adapted to bear against the rod, while the device secures to the fishing rod length using a series of attachments therealong.

Another object of the present invention is to provide a fishing rod alert device that further comprises an enclosed interior portion supporting a control circuit therein. The control circuit comprises a processor, a motion sensor, and a radio frequency transmitter for monitoring the motion of the device while attached to the fishing rod, and for sending wireless signals to the user's handheld electronic device.

Another object of the present invention is to provide a fishing rod alert device whereby the motion sensor measures movement of the elongated member when attached to the rod.

Another object of the present invention is to provide a fishing rod alert device whereby the processor receives signals from the motion sensor that correspond to the movement of the elongated member when attached to the rod. The processor analyzes the motion sensor signals and directs the radio frequency transmitter to send wireless signals to a third party receiver when the processor registers the movement of the elongated member that are determined to be a struck line.

Another object of the present invention is to provide a fishing rod alert device wherein each of the attachments further comprises a pair of rounded clips and/or strips of hook and loop fasteners that surround the fishing rod and secure the rod against the curved interior of the elongated member.

Another object of the present invention is to provide a fishing rod alert device wherein the processor measures the amplitude, slope, and frequency of the signals from the motion sensor to determine when a fish has struck a lure extended from the fishing rod.

Another object of the present invention is to provide a fishing rod alert device wherein the radio frequency transmitter further comprises a Bluetooth module that is adapted to pair with the third party receiver. The third party receiver further comprises a Bluetooth enabled device. In this way, the radio frequency transmitter sends wireless signals directly to the third party receiver. The third party receiver may comprise a handheld electronic device such as a smartphone or tablet device.

Another object of the present invention is to provide a fishing rod alert device wherein the device further comprises an audible alert in electrical connection with the processor. The processor directs the audible alert to activate an audio signal when the processor registers the movement of the elongated member based on the signals from the motion sensor.

Another object of the present invention is to provide a fishing rod alert device whereby the audible alert further comprises a speaker disposed along the elongated member.

Another object of the present invention is to provide a fishing rod alert device wherein the device further comprises a visual alert in electrical connection with the processor. The processor directs the visual alert to activate a visual signal when the processor registers the movement of the elongated member based on the signals from the motion sensor.

Another object of the present invention is to provide a fishing rod alert device whereby the visual alert further comprises a light source disposed along the elongated member.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of the fishing rod alert device of the present invention.

FIG. 2 shows an underside perspective view of the fishing rod alert device of the present invention.

FIG. 3 shows a view of the fishing rod alert device of the present invention being secured to the length of a fishing rod.

FIG. 4 shows a schematic of the control circuit of the present invention.

### DETAILED DESCRIPTION OF THE INVENTION

Reference is made herein to the attached drawings. Like reference numerals are used throughout the drawings to depict like or similar elements of the fishing rod alert device of the present invention. For the purposes of presenting a brief and clear description of the present invention, the preferred embodiment will be discussed as used for alerting a fishing user when a fishing lure extended from a fishing rod is struck. The figures are intended for representative purposes only and should not be considered to be limiting in any respect.

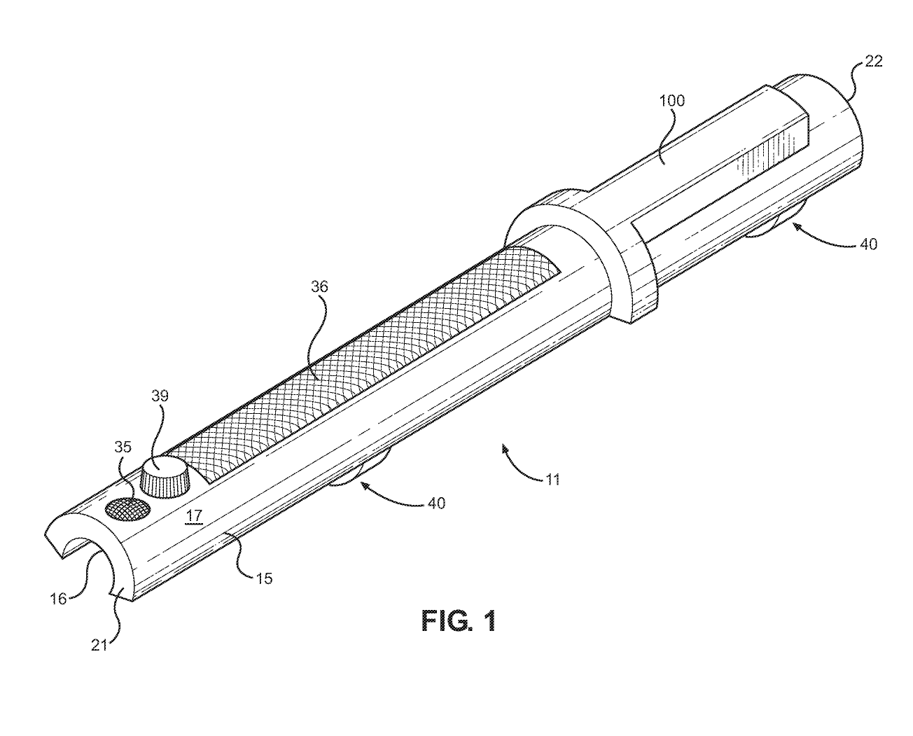

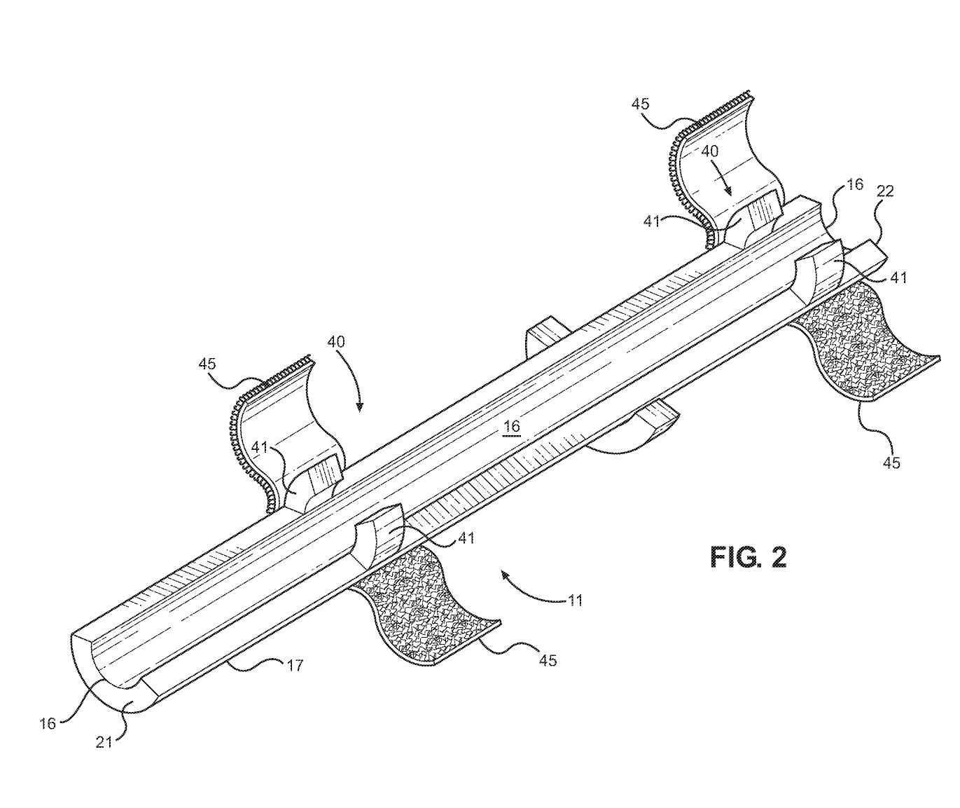

Referring now to FIGS. 1 and 2, there are shown perspective views of the fishing rod alert device of the present invention. The device 11 is one that is adapted to be positioned along the length of a fishing rod and used to measure the motion thereof while a lure is placed in a body of water. When a fish interacts with the lure, the fishing line will move and the fishing rod will move commensurately therewith. This movement is registered by the device 11 and is used to determine when a fish has engaged the lure, or “struck the line.” The device 11 of the present invention is one that is adapted to provide an alert to a remote user in the form of a wireless signal, either directly to a user's handheld device or through an intermediate network. The signal received by the user allows the user to be alerted when the line is struck and immediate attention to the fishing rod is required. This allows a user to monitor activity on a fishing line without being immediately present when a fish strikes the line.

The device 11 of the present invention is an elongated member that comprises a length 15, a first end 21, and a second end 22. The cross section of the member is preferably one having an arcuate shape with a curved lower surface 16. The curved lower surface 16 extends along the underside of the member 11 along its entire length 15, and is designed to receive a portion of the fishing rod thereagainst. The rounded rod of the fishing rod bears against the curved lower surface 16, whereby the device secures therearound. One or more sets of attachments 40 are used to secure the device 11 to the fishing rod along the length 15 of the device 11. In this manner, the device 11 is affixed to the rod of the fishing rod and can register displacement of the rod and/or flexion thereof when a lure is struck. The device 11 may comprises a rigid material that does not flex with the rod, or one of flexible construction to flex with the rod along the length 15 of the device 11.

Along the upper surface 17 of the device 11 is a housing 100 with an enclosed interior portion supporting a control circuit therein. The control circuit is an electrical assembly that controls the operation of the device, monitors the motion of the device, and transmits wireless signals to a third party receiver. In particular, the control circuit comprises a processor, a motion sensor, and a radio frequency transmitter. Motion of the device is registered by the motion sensor, which sends signals to the processor. The processor analyzes the motion signals and sends a wireless alert using the radio frequency transmitter when the motion is determined to be a struck line. In addition to the wireless signal, the device 11 may also include an audible and visual alert along the upper surface 15 when a struck line is detected. Specifically, a speaker 35 and light source 36 may additionally alert the user when the line of the fishing rod is struck.

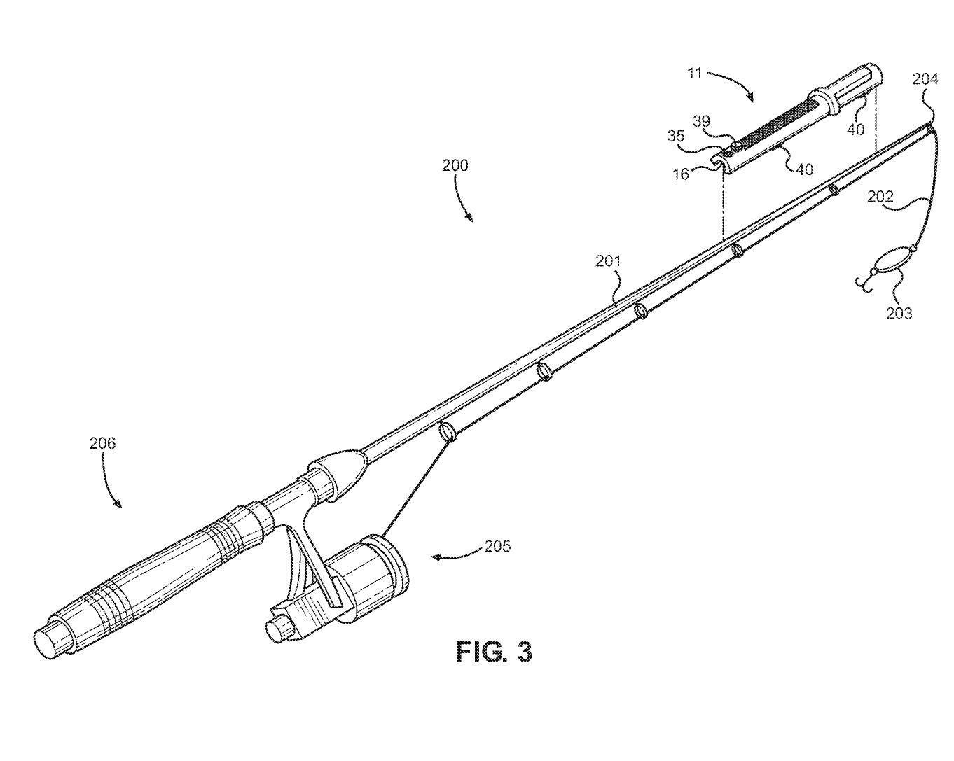

Referring now to FIG. 3, there is shown a view of the fishing rod alert device 11 being secured to the rod 201 of a fishing rod 200. The fishing rod alert device 11 comprises an elongated length and a rounded lower surface 16 that accepts the rounded fishing rod 201 therein. The attachments 40 secure around the rod 201 and affix the device 11 thereto along the length of the rod 201. Once in place, the motion sensor measures movement of the elongated member 11, which corresponds to movement of the rod 201 along its length and at the tip 204 of the rod. Movement is caused by a fish striking the lure 203, which causes vibrations along the line 202. The processor of the fishing rod alert device 11 receives signals from the motion sensor that correspond to the movement of the device 11 when attached to the rod 201. The processor then directs the radio frequency transmitter to send wireless signals to a third party receiver when the processor registers the movement of the device 11 based on the signals from the motion sensor. Therefore, when the lure 203 is struck and the line 202 moves the rod 201, movement of the rod 201 is registered by the motion sensor and analyzed by the processor to determine if the amplitude, frequency, and slope of the movements correspond to what could be determined as a fish striking the lure 203. The user can then grasp the handle 206 of the fishing rod 200 and reel in the fish on the lure 203 using the fishing reel 205.

In one embodiment provided in FIG. 2, each of the sets of attachments 40 that affix the device 11 to the fishing rod further comprises a pair of rounded clips 41 that surround a portion of the rod of a fishing rod and secure the rod against the curved interior 16 of the device 11. The clips 41 comprises rounded members that secure around the rounded rod and ensure the rod is maintained against the rounded interior 16 of the device 11. Multiple sets of clips along the device 11 secure the device 11 to the fishing rod along its length. In addition or in lieu of the clips 41, strips of hook and loop fastener material 45 may be provided to secure around the fishing rod and secure the rod to the device. The strips of hook and loop fastener material 45 are sets of attachments along the device that are adapted to surround the rod of a fishing rod and secure the rod against the curved interior of the elongated member.

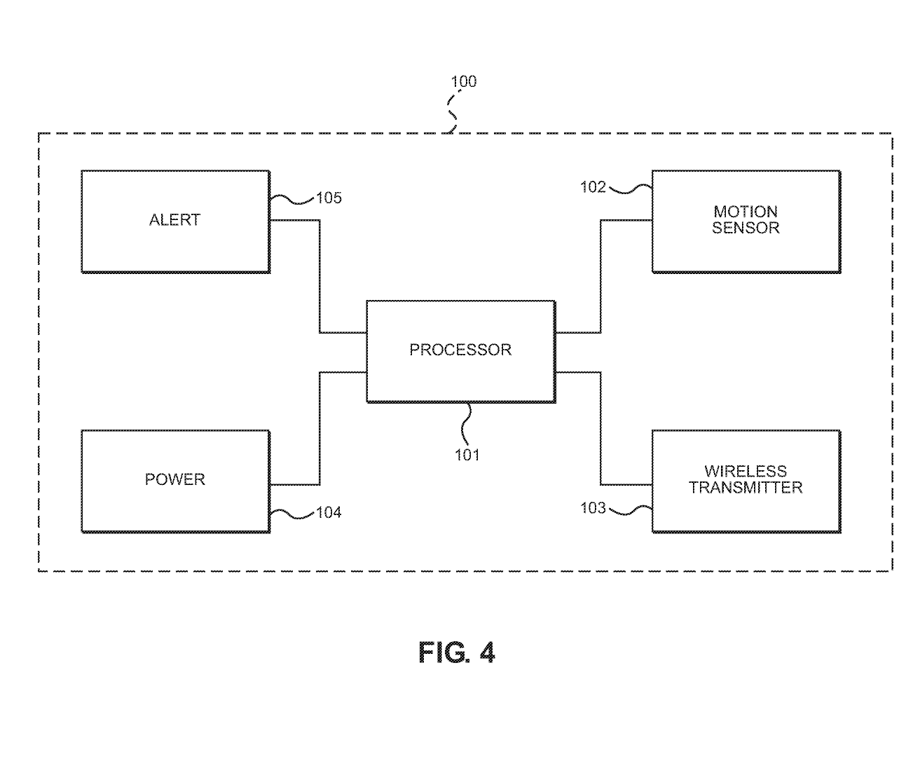

Referring now to FIG. 4, there is shown a view of the control circuit 100 of the present invention. The control circuit comprises a processor 101, a motion sensor 102, and a radio frequency transmitter 103. The processor 101 is preferably a microprocessor or equivalent digital device, which receives signals from the motion sensor 102 and directs the radio frequency transmitter 103 to send wireless signals to a third party receiver. The motion sensor 102 comprises one or more sensors that are capable of measuring motion along the length of the fishing rod alert device 11. These may include three-axis accelerometers or similar sensors that can develop an electric signal based on movement at the position of the sensor. Movement of the device 11 is used to measure movement of the rod, which in turn is used to determine when a fish has struck the line. Use of one or more sensors improves accuracy.

The radio frequency transmitter 103 is one that is adapted to communicate with a third party receiver. The transmitter 103 sends out radio frequency signals that are decoded by the third party receiver. The transmitter 103 may send signals directly to a user's handheld device in the form of a Bluetooth connection, or alternatively the transmitter 103 may be connected to a wireless network and send signals over the network to a third party server or router, which in turn sends signals to the third party receiver. Therefore, in one embodiment, direct communication with a third party receiver is accomplished using a radio frequency transmitter that comprises a Bluetooth module. The Bluetooth module is one that is adapted to pair with the third party receiver, whereby the third party receiver further comprises a Bluetooth enabled device. In one exemplary embodiment, the third party receiver is an electronic handheld device such as a smartphone, tablet, PDA, or similar device. In other embodiments, the signals are transmitted over a wireless network and routed to the user's handheld device. In this latter embodiment, the radio frequency transmitter comprises a wireless network antenna rather than a Bluetooth module.

In addition to sending wireless signals to a third party receiver, the fishing rod alert device 11 may also include visual and audible alerts. In particular, an audible alert in the form of a speaker may be provided, which is in electrical connection with the processor. The processor directs the audible alert to activate an audio signal when the processor registers the movement of the elongated member based on the signals from the motion sensor. Additionally, the fishing rod alert device 11 may include a visual alert in the form of a light source, which is in electrical connection with the processor. The processor directs the visual alert to activate a visual signal when the processor registers the movement of the elongated member based on the signals from the motion sensor. These alternative alerts supplement the wireless notification provided by the radio frequency transmitter.

For a fisherman user with several lines in the water, one or more devices may be deployed simultaneously. To this end, each device can be identified by the third party receiver based on a code that is unique to a specific device. In this manner, the user can monitor one or more devices (i.e. one or more fishing rods), and be alerted to exactly which rod is being struck by the radio frequency transmission. This lets the user know which rod is struck in the event there are multiple lines in use.

Overall, the present invention provides a fish strike notification system in which a fishing rod alert device is coupled with a third party receiver (i.e. a handheld device, etc.), which alerts a fisherman user of a struck line or hooked fish. It is not uncommon to have several lines in the water while fishing, or alternatively to leave a fishing area momentarily while a line is in the water. The present invention provides a means to notify a distant user that a fishing line has been struck and that action is necessary.

The fishing rod alert device maintains its affixed connection along the length of the fishing rod and monitors movement thereof for possible strikes on the fishing line. The attachments secure the device to the fishing rod, while additional hook-and-loop strips along the underside of the device may supplement the attachment to the rod. The device can identify movement on the end or along the length of the fishing rod, which often happens when a fish has been hooked. Upon identification of such movement, the transmitter sends a signal to a remote third party receiver, whereby the receiver may be one that is connected to the transmitter over a network or one that receives direct radio signals from the transmitter. Additional alerts can be present on the device, including local audio and visual alerts that energize when the device registers movement of the fishing rod.

The third party receiver is one that can be connected to the transmitter over a network and receive digital signals therefrom. Alternatively, the receiver may receive direct radio signals from the transmitter without an intermediate network. The third party receiver activates when a signal is received, and provides an alert for the user that may include audio, visual, or vibratory notifications. The sensitivity of the device can be adjusted for wind or wave action, whereby several continuous movements of the fishing rod may be necessary to trigger an actionable event. In particular, the processor may be programmed with a sensitivity level to only activate when certain motion signals are received that form a pattern or a recognizable strike on the fishing line. The sensitivity level can be set via an input on the device, or alternatively the third party receiver may be able to communicate with the processor to set a given sensitivity level. On the device 11 may be a sensitivity knob 39 that can be used by the user to manually adjust the sensitivity level across a given spectrum. The sensitivity level establishes a motion threshold, whereby the processor directs the radio frequency transmitter to send wireless signals to the third party receiver when the processor registers signals from the motion sensor above the threshold of the sensitivity level. In this way, the user can tailor the device to send a signal only after a given threshold of motion or vibration is reached.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An alert device affixable to a fishing rod to detect fish strikes, comprising:
an elongated member adapted to be placed along a rod of a fishing rod;
the elongated member having a length and an arcuate cross section with a curved interior that is adapted to bear against the rod;
two or more sets of attachments along the length of the elongated member that are adapted to secure the rod to the elongated member;
the elongated member having an enclosed interior portion supporting a control circuit;
the control circuit comprising a processor, a motion sensor, and a radio frequency transmitter;
whereby the motion sensor measures movement of the elongated member when attached to the rod;
whereby the processor receives signals from the motion sensor that correspond to the movement of the elongated member when attached to the rod;
whereby the processor directs the radio frequency transmitter to send wireless signals to a third party receiver when the processor registers the movement of the elongated member based on the signals from the motion sensor.

2) The alert device of claim 1, wherein each of the sets of attachments further comprises a pair of rounded clips that surround the rod of a fishing rod and secure the rod against the curved interior of the elongated member.

3) The alert device of claim 1, wherein each of the sets of attachments further comprises strips of hook and loop fastener material that are adapted to surround the rod of a fishing rod and secure the rod against the curved interior of the elongated member.

4) The alert device of claim 1, wherein:
the processor measures the amplitude, slope, and frequency of the signals from the motion sensor to determine when a fish has struck a lure extended from the fishing rod.

5) The alert device of claim 1, wherein:
a sensitivity level can be set that creates a threshold, whereby the processor directs the radio frequency transmitter to send the wireless signals to the third party receiver when the processor registers signals from the motion sensor above the threshold of the sensitivity level.

6) The alert device of claim 1, wherein:
the radio frequency transmitter further comprises a Bluetooth module that is adapted to pair with the third party receiver; and
whereby the third party receiver further comprises a Bluetooth enabled device.

7) The alert device of claim 1, wherein the third party receiver further comprises a handheld electronic device.

8) The alert device of claim 1, further comprising:
an audible alert in electrical connection with the processor;
whereby the processor directs the audible alert to activate an audio signal when the processor registers the movement of the elongated member based on the signals from the motion sensor.

9) The alert device of claim 8, whereby the audible alert further comprises a speaker disposed along the elongated member.

10) The alert device of claim 1, further comprising:
a visual alert in electrical connection with the processor;
whereby the processor directs the visual alert to activate a visual signal when the processor registers the movement of the elongated member based on the signals from the motion sensor.

11) The alert device of claim 10, whereby the visual alert further comprises a light source disposed along the elongated member.

12) The alert device of claim 1, wherein the wireless signals sent to the third party receiver further comprises a code associated with the alert device such that a user can identify the alert device.
